(19) United States
(12) Patent Application Publication
(10) Pub. No.: US 2007/0172645 A1
(43) Pub. Date: Jul. 26, 2007

(54) FIBER-REINFORCED LAYER INCLUDING A URETHANE POLYACRYLATE

(75) Inventors: Joseph Ogonowski, Newport, MI (US); David D. Peters, Wyandotte, MI (US); Calvin T. Peeler, Canton, MI (US)

Correspondence Address: BASF AKTIENGESELLSCHAFT, CARL-BOSCH STRASSE 38, 67056 LUDWIGSHAFEN, LUDWIGSHAFEN, 69056, DE

(73) Assignee: Matsushita Electric Industrial Co., Ltd, Osaka (JP)

(21) Appl. No.: 11/676,746

(22) Filed: Feb. 20, 2007

Related U.S. Application Data
(63) Continuation-in-part of application No. 10/832,903, filed on Apr. 27, 2004.

(51) Int. Cl. B32B 18/00; C08G 18/00

(52) U.S. Cl. 428/325; 528/44; 524/494

(57) ABSTRACT

A fiber-reinforced layer comprises A) a urethane polyacrylate and B) a fiber component. The urethane polyacrylate comprises the polymerization product of an acrylate component and a urethane acrylate. The urethane acrylate is the reaction product of an isocyanate component and a stoichiometric excess of the acrylate component. The isocyanate component has at least two isocyanate groups. The acrylate component has at least one functional group that is reactive with at least one of the isocyanate groups. The fiber component includes fibers having a length of less than or equal to about 0.25 inches present in an amount of at least 10 parts by weight based on 100 parts by weight of the fiber component. Rolling of the fiber-reinforced layer is unnecessary during making of the fiber-reinforced layer due to the presence of the fiber component and urethane polyacrylate in the fiber-reinforced layer and excellent physical properties are obtained even without rolling.

### CROSS REFERENCE TO RELATED APPLICATION

This application is a continuation-in-part of application Ser. No. 10/832,903 filed on Apr. 27, 2004.

### BACKGROUND OF THE INVENTION

1. Field of the Invention

The present invention relates to a fiber-reinforced layer. More specifically, the present invention relates to a fiber-reinforced layer that requires no or minimal rolling while providing physical properties similar to those of rolled fiber-reinforced layers.

2. Description of the Prior Art

Use of fiber-reinforced layers throughout the sports and recreation, automotive parts, and building supplies industries is known in the art. As is also known in the art, the fiber-reinforced layer is typically either a fiberglass reinforced polyester (FRP) layer or a reinforced polyurethane-based layer. The fiber-reinforced layers provide structural integrity and durability and are often used in conjunction with another layer that functions as a show surface, thereby forming a composite article. The composite article can be made up of multiple fiber-reinforced layers, with the polyester or polyurethane encapsulating various inserted material, such as fiberglass, wood, expanded metal sheets, cardboard honey comb and plate metal sheets and/or pieces.

One industrially accepted method for making fiber-reinforced layers involves spraying the FRP or polyurethane onto a substrate with the addition of the fiber from a stock of fiber roving via a chopping unit incorporating it into the FRP or polyurethane spray. The resulting fiber-reinforced layer typically requires rolling to align the fibers within the fiber-reinforced layer. However, both the FRP layer and the polyurethane-based layer present deficiencies during the manufacturing process that result in increased cost of production, inconsistent quality, environmental, health, and safety issues, or combinations of these problems.

For example, when the FRP layer is used, large quantities of styrene monomer, which is a volatile organic compound (VOC), are emitted. The emission of VOCs presents environmental, health, and safety issues, and is thus undesirable. As a result of the quantities of styrene monomer associated with the FRP layers of the prior art, among other sources of such VOCs, the Environmental Protection Agency (EPA) is enforcing restrictions to reduce or eliminate the emissions of such VOCs.

Polyurethane-based layers that are the reaction product of an isocyanate component and a polyol component have been developed in response to the environmental issues with the FRP layers. However, the polyurethane-based layers are also deficient for various reasons.

The polyurethane-based layers are sensitive to moisture during production. The isocyanate component will react with moisture, causing the final composite article to be porous. As a result, inconsistent quality of the polyurethane-based layer is an issue when the reaction occurs in the presence of moisture. Many of the common components in the polyurethane-based layer, such as wood, cardboard, and other fibers, are particularly problematic since these materials generally contain moisture. This presents a problem for the building supplies industry, for which composite articles including wood fibers are particularly useful.

Urethane acrylates have been developed in the prior art for use as additives in coating systems. For example, urethane acrylates are set forth in U.S. Pat. No. 5,908,875 to Smith et al. as additives in an unsaturated polyester resin composition to function as reactive diluents for replacing some of the styrene that is used to make the resulting polyester. The urethane acrylates are the reaction product of an isocyanate component and a functionalized acrylate component that is reactive with isocyanate. However, the urethane acrylates are only used as a reactive diluent in the unsaturated polyester resin compositions, and the resulting polymerized product is primarily a polyester polymer, with urethane acrylate molecules randomly copolymerized with unsaturated polyester molecules. Further, the urethane acrylate is made with a stoichiometric excess of the isocyanate component. The urethane acrylate must be in liquid form, i.e., in a non-cured state, so that the urethane acrylate can effectively function as the reactive diluent. Preferred urethane acrylates in Smith et al. include the reaction product of pentaerythritol acrylates and isocyanates, which produces a stable liquid prepolymer. As such, it is clear that the composition taught by Smith et al. is an unsaturated polyester resin, with the resulting polymer having properties that are consistent with those achieved by using unsaturated polyester resins.

Due to the deficiencies of the prior art, including those described above, it is desirable to provide a novel fiber-reinforced layer that is different from the layers in the prior art that are formed from the unsaturated polyester resins, and that minimizes usage of VOCs.

### SUMMARY OF THE INVENTION AND ADVANTAGES

The present invention provides a fiber-reinforced layer comprising A) a urethane polyacrylate and B) a fiber component. The urethane polyacrylate comprises the polymerization product of an acrylate component and a urethane acrylate. The urethane acrylate is the reaction product of an isocyanate component and a stoichiometric excess of the acrylate component. The isocyanate component has at least two isocyanate groups. The acrylate component has at least one functional group that is reactive with at least one of the isocyanate groups. The fiber component includes fibers having a length of less than or equal to about 0.25 inches present in an amount of at least 10 parts by weight based on 100 parts by weight of the fiber component.

The present invention further provides a method of making the fiber-reinforced layer comprising the steps of applying a urethane acrylate composition onto a substrate to form a layer of the urethane acrylate composition and incorporating the fiber component into the layer of the urethane acrylate composition to make the fiber-reinforced layer. The urethane acrylate composition includes the urethane acrylate and excess acrylate component that remains after the urethane acrylate is formed.

The fiber-reinforced layer including the urethane polyacrylate is different from those of the prior art. More specifically, urethane polyacrylates that comprise the polymerization product of the acrylate component and the urethane acrylate have not been used in fiber-reinforced layers. Further, by including the fiber component as described, in combination with the presence of the urethane polyacrylate in the fiber-reinforced layer, rolling of the fiber-reinforced layer is unnecessary, and similar physical properties to rolled FRP layers are obtained with the fiber-reinforced layer of the present invention even without rolling.

### DETAILED DESCRIPTION OF THE INVENTION

A fiber-reinforced layer of the present invention is useful in many applications, such as in composite articles for the boat, automotive parts, and building supplies industries. The composite articles may be used in those industries to perform barrier, structural, and/or aesthetic functions. One specific application in which the composite articles are particularly useful is for the hull of a boat, The composite articles include a first layer that is a show surface of the composite article and the fiber-reinforced layer. The fiber-reinforced layer provides structural integrity and durability to the complete composite article.

The fiber-reinforced layer includes a urethane polyacrylate. The urethane polyacrylate comprises the polymerization product of an acrylate component and a urethane acrylate. More specifically, the urethane acrylates referred to herein are monomers or oligomers, and the urethane polyacrylate includes repeating units resulting from vinyl co-polymerization of urethane acrylate monomers or oligomers with other urethane acrylate monomers or oligomers at their respective vinyl group(s), and with the acrylate component at the vinyl group. As described in further detail below, the urethane polyacrylate may further comprise the reaction product of reactive diluents, other than the acrylate component, which may be copolymerized with the urethane acrylate monomers or oligomers. However, the urethane polyacrylate primarily comprises the polymerization product of the acrylate component and urethane acrylate monomers or oligomers such that the urethane polyacrylate includes chains of polymerized acrylate component and urethane acrylate monomers or oligomers with other molecules randomly or block-copolymerized with and interrupting the chains. More detail with regards to the specific urethane polyacrylate of the present invention is provided below.

The urethane acrylate, i.e., the monomer or oligomer that is polymerized to form the urethane polyacrylate, is the reaction product of an isocyanate component and a stoichiometric excess of the acrylate component. The isocyanate component has at least two isocyanate groups, and the acrylate component has at least one functional group that is reactive with at least one of the isocyanate groups.

Preferably, the isocyanate component has from two to three isocyanate groups. The isocyanate component may be selected from the group of toluene diisocyanates, polymeric diphenylmethane diisocyanates, diphenylmethane diisocyanates, and combinations thereof. In one embodiment, the isocyanate component is a polymeric diphenylmethane diisocyanate, which is useful for providing polymeric functionality to the resulting urethane acrylate. Specific examples of preferred isocyanate components suitable for the urethane acrylate include, but are not limited to, Lupranate® M20S, Lupranate® MI, Lupranate® M70R, Lupranate® M200, and ELASTOFLEX® R23000. All are commercially available from BASF Corporation. As alluded to above, the isocyanate component may comprise a combination of isocyanates. That is, a blend of at least two different isocyanates may be utilized for reaction with the acrylate component to form the urethane acrylate.

Other suitable isocyanate components include, but are not limited to, conventional aliphatic, cycloaliphatic, araliphatic and aromatic isocyanates. Specific examples include: alkylene diisocyanates with 4 to 12 carbons in the alkylene radical such as 1,12-dodecane diisocyanate, 2-ethyl-1,4-tetramethylene diisocyanate, 2-methyl-1,5-pentamethylene diisocyanate, 1,4-tetramethylene diisocyanate, 1,6-hexamethylene diisocyanate, hexamethylene diisocyanate trimer (HDI Trimer), hexamethylene diisocyanate biuret (HDI Biuret); cycloaliphatic diisocyanates such as 1,3- and 1,4-cyclohexane diisocyanate as well as any combinations of these isomers, 1-isocyanato-3,3,5-trimethyl-5-isocyanatomethylcyclohexane (isophorone diisocyanate), isophorone diisocyanate trimer (IPDI Trimer), 2,4- and 2,6-hexahydrotoluene diisocyanate as well as the corresponding isomeric combinations, 4,4′-2,2′-, and 2,4′-dicyclohexylmethane diisocyanate as well as the corresponding isomeric mixtures, aromatic diisocyanates such as 2,4- and 2,6-toluene diisocyanate and the corresponding isomeric combinations, 4,4′-, 2,4′-, and 2,2′-diphenylmethane diisocyanate and the corresponding isomeric combinations; meta-tetramethylxylene diisocyanate (TMXDI), as well as combinations of any of the aforementioned isocyanate components.

As set forth above, the acrylate component has at least one functional group that is reactive with at least one of the isocyanate groups of the isocyanate component. Preferably, the acrylate component has from one to four functional groups. In a most preferred embodiment, the acrylate component has one functional group for providing sufficiently low viscosity to enable processing of the urethane acrylate during the production of the composite article.

Preferably, the functional groups are selected from the group of hydroxy-functional groups, amine-functional groups, and combinations thereof. Suitable hydroxy-functional groups include hydroxy-functional alkyl groups having from one to twenty carbon atoms. Specific examples of acrylate components including suitable hydroxy-functional groups includes but are not limited to, hydroxyethyl, hydroxypropyl, and hydroxybutyl acrylates and alkacrylates, and combinations thereof. It is to be appreciated that the acrylates may include more than one of the aforementioned hydroxy-functional groups and may be incorporated as a prepolymer as described above.

Preferably, the acrylate component includes at least one alkyl group having from 1 to 20 carbon atoms. Specific examples of acrylate components including suitable alkyl groups include methacrylates, ethacrylates, propacrylates, butacrylates, phenylacrylates, methacrylamides, ethacrylamides, butacrylamides, and combinations thereof. Preferred acrylate components include hydroxymethyl methacrylate, hydroxyethyl methacrylate, hydroxypropyl methacrylate, hydroxyethyl ethacrylate, hydroxypropyl ethacrylate, glycerol dimethacrylate, N-methylol methacrylamide, 2-tert-butyl aminoethyl methacrylate, dimethylaminopropyl methacrylamide, and combinations thereof. In a most preferred embodiment, the acrylate component is a hydroxyethyl methacrylate.

The excess acrylate component that remains after all of the isocyanate component is reacted is available for reaction with the urethane acrylate monomers or oligomers through vinyl polymerization at the respective vinyl groups, as set forth above.

Many urethane acrylates, prior to reaction to form the urethane polyacrylates, have a high viscosity, making the urethane acrylates difficult to spray. The viscosity of the urethane acrylates may be adjusted by varying the acrylate components according to the number of functional groups per acrylate component and by varying the amount of the acrylate component with respect to the isocyanate component. The acrylate component is provided in a stoichiometric excess with respect to the isocyanate component to function as a reactive diluent for lowering the viscosity of the urethane acrylate. Preferably, the stoichiometric excess of the acrylate component is defined as a range of molar equivalent ratios of the acrylate component to the isocyanate component of from 3:1 to 1.05:1. More preferably, the stoichiometric excess is defined as a range of molar equivalent ratios of from 2.5:1 to 1.05:1. In a most preferred embodiment, the stoichiometric excess is defined as a range of molar equivalent ratios of from 2:1 to 1.05:1. The actual amounts by weight of the acrylate component and the isocyanate component will vary depending on the specific acrylate or mixture of acrylates used, as well as with the specific isocyanate and/or isocyanate mixture used.

As set forth above, reactive diluent other than the acrylate component may be used primarily to further lower the viscosity of the mixture. The reactive diluent is typically reactive with the urethane acrylate. As such, the urethane polyacrylate may further comprise the reaction product of the reactive diluent. The reactive diluent preferably has at least one acrylate-reactive functional group selected from the group of vinyl groups, allyl groups, cyclic allyl groups, cyclic vinyl groups, acrylic groups, functionalized acrylate groups, acrylamide groups, acrylonitrile groups, and combinations thereof for reacting with acrylate groups of the urethane acrylate during polymerization to form the urethane polyacrylate. Specific examples of reactive diluents that are suitable for the subject invention include, but not limited to styrene, divinyl benzene, allyl alkacrylates, vinyl toluene, diacetone acrylamide, acrylonitrile, methyl methacrylate, hydroxyethyl methacrylate, hydroxypropyl methacrylate, alpha methyl styrene, butyl styrene, monochlorostyrene and combinations thereof.

Preferably, the weight ratio of the reactive diluent to the urethane acrylate is at least 0.01:1, more preferably from 0.1:1 to 1:1. In terms of actual amounts by weight, the reactive diluent is preferably present in an amount of at least 1.0 parts by weight, more preferably from 1.0 to 40 parts by weight, most preferably from 5 to 25 parts by weight based on the 100 parts by weight, on a pre-reaction basis, of all components that are reacted to form the urethane polyacrylate.

Preferably, a catalyst is further included in the urethane acrylate. In one embodiment, the catalyst is a temperature-activated catalyst which is activated with heat after the fiber-reinforced layer is formed, a specific example of which is cumene peroxide. Alternatively, the catalyst may be selected from the group of photo-initiated, peroxide-based, amine-based, and metal-based catalysts. Specific examples of such catalysts include hydrogen peroxide, dibenzoyl peroxide, acetyl peroxide, benzoyl hydroperoxide, t-butyl hydroperoxide, di-t-butyl peroxide, lauroyl peroxide, butyryl peroxide, diisopropylbenzene hydroperoxide, cumene hydroperoxide, paramethane hydroperoxide, diacetyl peroxide, di-alpha-cumyl peroxide, dipropyl peroxide, diisopropyl peroxide, isopropyl-t-butyl peroxide, butyl-t-butyl peroxide, difuroyl peroxide, bis (triphenylmethyl) peroxide, bis(p-methoxybenzoyl)peroxide, p-monomethoxybenzoyl peroxide, rubene peroxide, propyl hydroperoxide, isopropyl hydroperoxide, n-butyl hydroperoxide, t-butyl hydroperoxide, cyclohexyl hydroperoxide, trans-decalin hydroperoxide, alpha-methylbenzyl hydroperoxide, alpha-methyl-alpha-ethyl benzyl hydroperoxide, tetralin hydroperoxide, triphenylmethyl hydroperoxide, diphenylmethyl hydroperoxide, benzoyl peroxide, organic tin compounds such as tin (II) salts of organic carboxylic acids, e.g., tin (II) acetate, tin (II) octoate, tin (II) ethylhexanate and tin (II) laurate, and the dialkyltin (IV) salts of organic carboxylic acids, e.g., dibutyltin diacetate, dibutyltin dilaurate, dibutyltin maleate, dioctyltin diacetate, cobalt octoate, cobalt napthanate, and combinations thereof. Additional catalysts include dimethyl-para-toluidine (DMPT), dimethylaniline (DMA), diethylaniline (DEA), and combinations thereof.

Preferably, the total amount of catalyst present in the urethane acrylate is from 0.02 to 7 parts by weight, more preferably from 0.5 to 5 parts by weight, based on 100 parts by weight, on a pre-reaction basis, of all components that are reacted to form the urethane polyacrylate to ensure sufficient cure and cross-linking during polymerization of the urethane acrylate

The viscosity of the combined urethane acrylate and any reactive diluents or catalysts to be used therein, prior to reaction, is preferably sufficiently low to enable spray application during the production of the fiber-reinforced layer. The viscosity is preferably from 50 to 600 centipoise, more preferably from 100 to 300 centipoise, most preferably from 150 to 250 centipoise at 77° F. Lower viscosities within the above-stated ranges are desirable under certain circumstances, such as when fillers are present in the fiber-reinforced layer. Resulting viscosities of the combined urethane acrylate, reactive diluent(s), and the filler may be up to 10,000 centipoise at 77° F, with a thixotropic index of from 2.4 to 10.

The urethane polyacrylate that includes the polymerization product of the acrylate component and the urethane acrylate includes urethane acrylate units of the following formula: 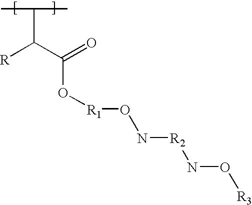
wherein R is an alkyl group having from 1 to 20 carbon atoms, R₁ is a group having from 2 to 20 carbon atoms, R₂ is a group selected from a toluene group, a diphenylmethane group, a polymeric diphenylmethane diisocyanate group, and combinations thereof, and R₃ is represented by at least one of the following formulae: 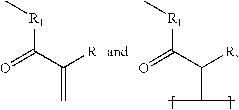
wherein R and R₁ are the same as set forth above. It is to be appreciated that, when R₂ is polymeric diphenylmethane diisocyanate group, branching (not shown) may be introduced through R₂. The urethane polyacrylate further comprises units representative of the acrylate component, represented by the following formula: 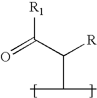
wherein R and R₁ are the same as set forth above. It is also to be appreciated that, when the reactive diluent is used, the urethane polyacrylate may further comprise units representative of the reactive diluent subsequent to vinyl polymerization, as well as units representative of unreacted acrylate component. The number of urethane acrylate units represented by the above formula, the number of units representative of the reactive diluent, and the number of units representative of the unreacted acrylate component are dependent upon the amount of the urethane acrylate, excess acrylate component, and reactive diluent that are reacted.

The urethane polyacrylate is typically present in the fiber-reinforced layer in an amount of at least 25 parts by weight, more preferably from 30 to 70 parts by weight, based on 100 parts by weight of the fiber-reinforced layer.

The fiber-reinforced layer further includes a fiber component. The fiber component is included in the support layer to reinforce the composite structure, to eliminate fault propagation, and to provide support for the fiber-reinforced layer and the composite article. Suitable fibers that may be included in the fiber composition include, but are not limited to, chopped fiberglass, chopped carbon fibers, chopped wood fibers, chopped aramid fibers including all aromatic polyamide materials, chopped polymer fibers such as nylon, and combinations thereof.

The fiber component includes fibers having a length of less than or equal to about 0.25 inches. The fibers having the specified length of less than or equal to about 0.25 inches are present in an amount of at least 10 parts by weight, more preferably from 10 to 75 parts by weight, most preferably from 30 to 75 parts by weight, based on 100 parts by weight of the fiber component. In addition, the fiber component typically further includes fibers having a length in excess of 0.25 inches present in an amount of less than 50 parts by weight, more typically less than 20 parts by weight, most typically less than 5 parts by weight, based on 100 parts by weight of the fiber component. By including the fibers having the above-specified lengths in the amounts specified, physical properties of the fiber-reinforced layer can be achieved that are comparable to those that are obtained with convention FRP layers. Significantly, such physical properties can be achieved in the absence of a step of rolling the fiber-reinforced layer during making of the layer due to the presence of the fibers having the above-specified length in the amount specified. In particular, the longer fibers are more prone to protruding from the fiber-reinforced layer absent rolling, and by including less than 5 parts by weight of the longer fibers in the fiber-reinforced layer, rolling is unnecessary to prevent significant amounts of the fiber from protruding from the fiber-reinforced layer. Further, rolling is typically necessary in the prior art to compress the fiber-reinforced layers and to prevent sloughing-down of resin that is used to make the fiber-reinforced layers prior to curing of the resin. The urethane acrylates of the present invention cure sufficiently fast to prevent sloughing-down of the urethane acrylate composition, thus eliminating the need to compress the fiber-reinforced layer through rolling. The physical properties of the fiber-reinforced layer are described in further detail below.

The fiber component, as a whole, is typically present in the fiber-reinforced layer in an amount of from 30 to 50 parts by weight, based on the total weight of the fiber-reinforced layer, to enable the desirable physical properties of the fiber-reinforced layer to be obtained.

The fiber-reinforced layer may further comprise an additive or additives. If included, the additive may be selected from the group of surfactants, plasticizers, polymerization inhibitors, antioxidants, compatibilizing agents, supplemental cross-linking agents, flame retardants, anti-foam agents, UV performance enhancers, hindered amine light stabilizers, pigments, thixotropic agents, reactive fillers, non-reactive fillers, and combinations thereof. Other suitable additives include, but are not limited to, cell regulators, hydrolysis-protection agents, fungistatic and bacteriostatic substances, dispersing agents, adhesion promoters, and appearance enhancing agents. Each of these additives serves a specific function, or functions, that are known to those skilled in the art.

Notably, the urethane polyacrylate in the fiber-reinforced layer is typically free of polyester. More specifically, unsaturated polyester's are typically absent from the urethane acrylate component, and the urethane polyacrylate is free from polyester linkages.

The fiber-reinforced layer is preferably at least 0.125 inches thick, based on the physical requirements of the final composite article. In terms of physical properties of the fiber-reinforced layer, the fiber-reinforced layer typically has at least acceptable heat distortion and hardness, while having an accelerated cure cure rate and providing other physical properties that are superior when compared to the standard polyester resin-based composite. For example, the fiber-reinforced layer typically has an original peak tensile strength of at least 5500 psi, an original break elongation of at least 5.5%, and an original flex strength of at least 12000 psi

As set forth above, the composite article includes the first layer that is the show surface of the composite article. In one embodiment, the first layer includes a styrenated unsaturated polyester. An example of a typical styrenated unsaturated polyester is Vipel® F737-FB Series Polyester Resin (formerly E737-FBL). Preferably, the styrenated unsaturated polyester of the first layer has a nominal styrene content of from 25 to 50 parts by weight based on the total weight of the polyester. Most preferably, the nominal styrene content of the styrenated unsaturated polyester is 30 to 45 parts by weight based on the total weight of the polyester. The styrenated unsaturated polyester is the product of a condensation reaction between difunctional acids and alcohols, one of which contributes olefinic unsaturation. The polyester is dissolved in styrene or another monomeric material having vinyl unsaturation. Typically, the polyester is formed from a phthalic acid, maleic anhydride, or fumaric acid and propylene glycol. The phthalic acid is most preferably isophthalic acid and the organic compound is most preferably a difunctional alcohol. Available hydrogen atoms from the isophthalic acid are replaced with an organic group from the alcohol to form the polyester. One styrenated unsaturated polyester suitable for use in the subject invention is commercially available as Vipel® F737-FB Series Polyester Resin (formerly E737-FBL) from AOC Resins of Collierville, Tenn.

In another embodiment, the first layer includes a second urethane polyacrylate that is the polymerization product of a second acrylate component and a second urethane acrylate. The second urethane acrylate may be the same as the urethane acrylate used to make the fiber-reinforced layer. However, it is to be appreciated that a second isocyanate component and the second acrylate component that is used to make the second urethane polyacrylate may be different from the isocyanate component of the fiber-reinforced layer.

Depending on the intended use of the composite article, the second isocyanate component may preferably be an aliphatic isocyanate, such as under circumstances in which the composite articles are exposed to direct sunlight, especially when UV transparent additives, such as TiO₂ pigment, are utilized. Whenever the term aliphatic is used throughout the subject application, it is intended to indicate any combination of aliphatic, acyclic, and cyclic arrangements. That is, aliphatic indicates both straight chains and branched arrangements of carbon atoms (non-cyclic) as well as arrangements of carbon atoms in closed ring structures (cyclic) so long as these arrangements are not aromatic. Urethane acrylates made from aliphatic isocyanates are more stable to UV light than urethane acrylates that are made from aromatic isocyanates. Alternatively, the second isocyanate component may also include aromatic isocyanates so long as at least one UV performance-enhancing additive is included such that the first layer is stable under exposure to UV light. For composite articles where UV stability is not critical, any isocyanate may be used,

In another embodiment, the first layer may be formed from a paint for enhancing the appearance of the composite article. It is to be understood that the paint may include any pigment known in the art, such as the TiO₂ as set forth above, or any other paint as known in the art for including in the first layer that is the show surface. Other examples of paint suitable for the subject invention include paint selected from the group of latex-based water-borne, latex-based solvent-borne, acrylic-based water-borne, and acrylic-based solvent-borne paints.

It is to be appreciated that the composite article may include additional layers. For example, the composite article may include a second layer disposed between the first layer and the fiber-reinforced layer. When present, the second layer may include another urethane polyacrylate that may be the same as any of the urethane polyacrylates described above. However, it is to be appreciated that the second layer may be formed from other polymers, such as polyurethanes. The second layer preferably has a smooth texture for improving the appearance of the first layer. More specifically, the second layer may be present to provide a smooth surface for the first layer, whereas the fiber-reinforced layer may have a rough texture due to the presence of the fiber component therein.

The fiber-reinforced layer is typically made by applying a urethane acrylate composition onto a substrate to form a layer of the urethane acrylate composition The substrate is typically a surface of a mold substrate. The urethane acrylate composition includes the urethane acrylate, the reactive diluent, the catalyst, and any additives that are to be included in the fiber-reinforced layer. The urethane acrylate composition comprises the urethane acrylate in an amount of at least 25 parts by weight, based on 100 parts by weight of the urethane acrylate composition.

The fiber-reinforced layer is typically included in the composite article as described above. As such, for simplicity, the following description is in terms of a method of making the composite article; however, it is to be appreciated that the method of the present invention is not limited to making composite articles. The composite article may be formed through an open-mold process or a closed mold process. Preferably, the surface of the mold substrate is coated with a known mold release agent to facilitate the eventual removing of the composite article. By way of non-limiting example, the mold release agent may be a composition including silicones, soaps, waxes and/or solvents. For the open-mold process, the first layer is formed over the mold release agent on the surface of the mold substrate. Preferably, the first layer is cured at room temperature of about 77° F. for a length of time sufficient to prevent bleeding and read through, but not so long as to prevent bonding to the fiber-reinforced layer. Typically, the first layer is cured for about one hour.

The urethane acrylate composition is applied onto the first layer to form a layer of the urethane acrylate composition. The urethane acrylate composition has sufficiently low viscosity to enable spraying of the urethane acrylate composition during production of the composite article. It is to be appreciated that the urethane acrylate composition may be poured or injected; however, spraying is preferred for certain composite articles. The fiber component is incorporated into the layer of the urethane acrylate composition to make the fiber-reinforced layer. The fiber component may be incorporated through any method known in the art for doing so, such as by chopping the fiber from a feed stock and introducing the chopped fiber with the urethane acrylate composition simultaneously with applying the urethane acrylate composition, or by chopping the fiber after applying the urethane acrylate composition and introducing the chopped fiber onto the layer of the urethane acrylate composition. As set forth above, the fiber-reinforced layer is typically made in the absence of a step of rolling the fiber-reinforced layer. The layer of the urethane acrylate is then cured at a temperature of from about 60° F. to about 95° F. for a period of about 1 hour to sufficiently polymerize the urethane acrylate and, if present, the reactive diluent and to form the urethane polyacrylate.

In another embodiment, the urethane acrylate composition may be applied to the surface of the mold substrate and the fiber component may be incorporated into the layer of the urethane acrylate composition to form the fiber-reinforced layer. The fiber-reinforced layer may be removed prior to forming the first layer. The first layer may then be formed on the finer-reinforced layer outside of the mold substrate in a post production paint operation.

In yet another embodiment, the composite article may be made by first forming the first layer in the mold, forming the second layer on the first layer, and forming the fiber-reinforced layer on the second layer,. The complete composite article is then removed from the mold. Alternatively, the composite article may be produced by forming the second layer in the mold, forming the fiber-reinforced layer on the second layer, removing the second and fiber-reinforced layers from the mold, and then forming the first layer on the second layer outside of the mold to produce the complete composite article.

### EXAMPLES

Fiber-reinforced layer of the subject invention are formed as set forth above. More specifically, a urethane acrylate composition including a urethane acrylate and a catalyst is sprayed onto a substrate to form a layer of the urethane acrylate composition. The urethane acrylate comprises the reaction product of an isocyanate component and a stoichiometric excess of an acrylate component. The excess acrylate component functions as a reactive diluent. A fiber, component is incorporated into the layer of the urethane acrylate composition by chopping fiber to a length of about 0.25 inches from a feedstock and simultaneously introducing the fiber component into the layer of the urethane acrylate composition during spraying of the urethane acrylate composition. While the fiber is chopped to have a length of about 0.25 inches, it is to be appreciated that some longer fibers may be introduced as a result of process inefficiencies; however, fibers longer than 0.25 inches are not intentionally introduced into the urethane acrylate composition. The glass fibers are then compressed by rolling with rollers having a 1 inch diameter. A smaller diameter roller is used to compress the fibers into tight radiuses and other restricted areas of the composite article. The layer of the urethane acrylate is then cured at a temperature of from about 65° F. to about 80° F. for a period of about 1 hour to sufficiently polymerize the urethane acrylate and the excess acrylate component and to form the urethane polyacrylate. Example 2 is a fiber-reinforced layer identical to Example 1 described above, except that the fiber-reinforced layer is not rolled.

Comparative Examples are also made for providing a basis for comparison to the physical properties of the fiber-reinforced layer of the present invention. Comparative Example A is similar to Example 1 but uses a fiber having a length of from ½ to 1 inch and is rolled with the 1 inch diameter roller. Comparative Example B is similar to Comparative Example A, however the composite article is not rolled to compress the glass fibers. Comparative Example C is a typical styrenated polyester based resin composite prepared with the incorporation of glass fibers having a length of 1.5 inches and rolled. Specific resin compositions, as well as fiber length and loading and physical properties of the resulting fiber-reinforced layers, are set forth in Table 1.

TABLE 1

| | | | Comp. | Comp. | Comp. |
|---|---|---|---|---|---|
| Component | Ex. 1 | Ex. 2 | Ex. A | Ex. B | Ex. C |
| Polyester Resin | 0.0 | 0.0 | 0.0 | 0.0 | 100.0 |
| Urethane Acrylate | 98.9 | 98.9 | 98.9 | 98.9 | 0.0 |
| Catalyst A | 0.1 | 0.1 | 0.1 | 0.1 | 0.0 |
| Catalyst B | 0.1 | 0.1 | 0.1 | 0.1 | 0.0 |
| Catalyst C | 0.8 | 0.8 | 0.8 | 0.8 | 0.0 |
| Additive A | 0.1 | 0.1 | 0.1 | 0.1 | 0.0 |
| Total Weight, Wet Basis | 100.0 | 100.0 | 100.0 | 100.0 | 100.0 |
| Fiber Component, % based on | 27.2 | 30.3 | 40.5 | 28.6 | 32.8 |
| Total Weight of All Components | | | | | |
| Original Peak Tensile Strength, psi | 5767 | 6588 | 16847 | 7616 | 13313 |
| Original Break Elongation, % | 6.10 | 5.70 | 8.20 | 5.67 | 5.9 |
| Original Flex Strength, psi | 12394 | 14435 | 28900 | 16246 | 10025 |
| Original Flex Modulus, psi | 918034 | 919672 | 1546264 | 758508 | 100072 |
| Notched IZOD Impact Strength, | 3.60 | 5.10 | 17.40 | 9.60 | 11.7 |
| Foot-Pounds/Inch | | | | | |
| Heat Distortion Temperature at 264 psi | 246 | 244 | >300 | 275 | >300 |

Polyester resin is LB-6541-004 polyester resin commercially available from Ashland Chemicals.

Urethane acrylate is a 2/1 equivalent ratio reaction product of hydroxyethyl methacrylate and Lupranate M70L isocyanate prepared using Dabco T-12 Catalyst and BHT, as described in copending U.S. Patent Publication No. 2005/0238883, with excess hydroxyethyl methacrylate functioning as reactive diluent.

Hydroxyethyl methacrylate is a 98% (HEMA) solution, commercially available from Degussa.

Lupranate® M70L Isocyanate is a commercially available polymeric diphenylmethane diisocyanate (PMDI) with a functionality of approximately 2.7 and a NCO content of approximately 31.4 parts by weight, commercially available from BASF Corp.

Dabco T-12 is dibutyltin dilaurate commercially available from Air Products and Chemicals, Inc.

BHT is Butylated hydroxyl toluene.

Catalyst A is a 12% cobalt solution, commercially available from OMG Americas, Inc.

Catalyst B is potassium octoate commercially available from Air Products and Chemicals, Inc.

Catalyst C is Cumene hydroperoxide.

Additive A is a polysiloxane anti-foam agent in diisobutylketone solvent commercially available from Byk Chemie.

Fiber component is fiberglass typically used for composite construction commercially available from Owens-Corning Corporation.

Referring to Table 1 above, it is notable that Example 2, which is identical to Example 1 but which is not rolled, exhibits consistently improved physical properties as compared to Example 1, which is rolled. Such improvements in the physical properties of the non-rolled article were unexpected, since rolling typically results in better physical properties as evidenced from a comparison of physical properties of Comparative Examples A and B, which were made with longer fibers than in Examples 1 and 2.

The invention has been described in an illustrative manner, and it is to be understood that the terminology which has been used is intended to be in the nature of words of description rather than of limitation, Obviously, many modifications and variations of the present invention are possible in light of the above teachings, and the invention may be practiced otherwise than as specifically described.

What is claimed is:

1. A fiber-reinforced layer comprising:
(A) a urethane polyacrylate comprising the polymerization product of an acrylate component and a urethane acrylate that is the reaction product of:
(I) an isocyanate component having at least two isocyanate groups; and
(II) a stoichiometric excess of the acrylate component having at least one functional group that is reactive with at least one of said isocyanate groups; and
(B) a fiber component including fibers having a length of less than or equal to about 0.25 inches present in an amount of at least 10 parts by weight based on 100 parts by weight of said fiber component.

2. A fiber-reinforced layer as set forth in claim 1 wherein said fiber component further includes fibers having a length in excess of 0.25 inches present in an amount of less than 50 parts by weight based on 100 parts by weight of said fiber component.

3. A fiber-reinforced layer as set forth in claim 2 wherein said fiber component is present in an amount of from 30 to 50 parts by weight based on 100 parts by weight of said fiber-reinforced layer.

4. A fiber-reinforced layer as set forth in claim 1 wherein said stoichiometric excess of said acrylate component is further defined as a range of molar, equivalent ratio of said acrylate component to said isocyanate component of from 3:1 to 1.05:1.

5. A fiber-reinforced layer as set forth in claim 1 wherein said isocyanate component is selected from the group of toluene diisocyanates, polymeric diphenylmethane diusocyanates, diphenylmethane diisocyanates, and combinations thereof.

6. A fiber-reinforced layer as set forth in claim 1 wherein said urethane polyacrylate includes urethane acrylate units of the following formula: 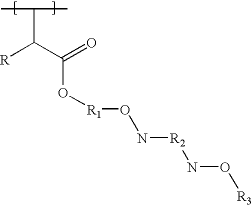
wherein R is an alkyl group having from 1 to 20 carbon atoms, R₁ is a group having from 2 to 20 carbon atoms, R₂ is a group selected from a toluene group, a diphenylmethane group, a polymeric diphenylmethane diisocyanate group, and combinations thereof, and R₃ is represented by at least one of the following formulae:

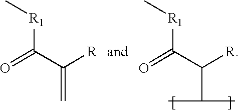

7. A fiber-reinforced layer as set forth in claim 6 wherein said urethane polyacrylate further comprises the reaction product of a reactive diluent having at least one acrylate-reactive functional group selected from the group of vinyl groups, allyl groups, cyclic allyl groups, cyclic vinyl groups, acrylic groups, functionalized acrylate groups, acrylamide groups, acrylonitrile groups, and combinations thereof.

8. A fiber-reinforced layer as set forth in claim 1 wherein said urethane polyacrylate further comprises the reaction product of a reactive diluent having at least one acrylate-reactive functional group selected from the group of vinyl groups, allyl groups, cyclic allyl groups, cyclic vinyl groups, acrylic groups, functionalized acrylate groups, acrylamide groups, acrylonitrile groups, and combinations thereof.

9. A fiber-reinforced layer as set forth in claim 1 wherein said urethane polyacrylate is free of polyester.

10. A fiber-reinforced layer as set forth in claim 1 wherein said urethane polyacrylate is present in said fiber-reinforced layer in an amount of at least 25 parts by weight based on 100 parts by weight of said fiber-reinforced layer.

11. A fiber-reinforced layer as set forth in claim 1 wherein said urethane acrylate is reacted in an amount of at least 25 parts by weight based on 100 parts by weight, on a pre-reaction basis, of all components that are reacted to form the urethane polyacrylate.

12. A fiber-reinforced layer as set forth in claim 1 further defined as a non-rolled fiber-reinforced layer made in the absence of a step of rolling the fiber-reinforced layer.

13. A non-rolled fiber-reinforced layer as set forth in claim 12 having an original peak tensile strength of at least 5500 psi.

14. A non-rolled fiber-reinforced layer as set forth in claim 13 having an original break elongation of at least 5.5%.

15. A non-rolled fiber-reinforced layer as set forth in claim 13 having an original flex strength of at least 12000 psi.

16. A composite article including a fiber-reinforced layer as set forth in claim 1 and a first layer that is a show surface of said composite article.

17. A composite article as set forth in claim 16 wherein said first layer comprises a styrenated unsaturated polyester.

18. A method of making a fiber-reinforced layer, said method comprising the steps of:
applying a urethane acrylate composition onto a substrate to form a layer of the urethane acrylate composition, the urethane acrylate composition comprising a urethane acrylate in an amount of at least 25 parts by weight based on 100 parts by weight of the urethane acrylate composition, the urethane acrylate comprising the reaction product of:
(I) an isocyanate component having at least two isocyanate groups; and
(II) a stoichiometric excess of an acrylate component having at least one functional group that is reactive with at least one of said isocyanate groups; and
incorporating a fiber component including fibers having a length of less than or equal to about 0.25 inches present in an amount of at least 10 parts by weight based on 100 parts by weight of said fiber component into the layer of the urethane acrylate composition to make the fiber-reinforced layer.

19. A method as set forth in claim 18 wherein the fiber component further includes fibers having a length in excess of 0.25 inches present in an amount of less than 50 parts by weight based on 100 parts by weight of the fiber component.

20. A method as set forth in claim 19 wherein said fiber component is present in an amount of from 30 to 50 parts by weight based on 100 parts by weight of the fiber-reinforced layer.

21. A method as set forth in claim 18 wherein the fiber-reinforced layer is made in the absence of a step of rolling the fiber-reinforced layer.

22. A method as set forth in claim 18 further comprising the step of curing the urethane acrylate composition in the fiber-reinforced layer to form urethane polyacrylate including urethane acrylate units of the following formula: 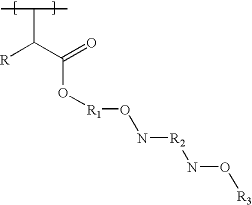
wherein R is an alkyl group having from 1 to 20 carbon atoms, R₁ is a group having from 2 to 20 carbon atoms, R₂ is a group selected from a toluene group, a diphenylmethane group, a polymeric diphenylmethane diisocyanate group, and combinations thereof, and R₃ is represented by at least one of the following formulae: [chemical structure]
